(19) United States
(12) Patent Application Publication
(10) Pub. No.: US 2017/0209005 A1
(43) Pub. Date: Jul. 27, 2017

(54) MULTI-SURFACE SCRUBBING DEVICE

(71) Applicant: Nancy Manon Bullett, Welland (CA)

(72) Inventor: Nancy Manon Bullett, Welland (CA)

(21) Appl. No.: 15/416,886

(22) Filed: Jan. 26, 2017

Related U.S. Application Data
(60) Provisional application No. 62/287,271, filed on Jan. 26, 2016.

(51) Int. Cl. A47K 7/03; B08B 1/00

(52) U.S. Cl. CPC A47K 7/03; B08B 1/006

(57) ABSTRACT

Described herein is a scrubbing device. The scrubbing device designed for placement within the palm of a user's hand. The scrubbing device comprised of a bag portion defining an exterior scrubbing surface and interior cavity. The interior cavity including a plurality of rigid beads. The combination of bag portion and the bead portion creating a device with increased surface area for scrubbing.

### CROSS REFERENCE TO RELATED APPLICATIONS

This application claims priority to U.S. Provisional Patent Application No. 62/287,271 filed 26 Jan. 2016 to the above named inventor, and is herein incorporated by reference in its entirety.

### FIELD OF THE INVENTION

The invention relates generally to a flexible and deformable cleaning and scrubbing device for use in cleaning household surfaces, vehicles, or to be used as a body scrub in the shower or bathtub.

### BACKGROUND

Currently there are a number of solutions for cleaning kitchen, bathroom, and other similar surfaces. One of these solutions attempts to use a sponge in combination with a cleaner, but this solution fails to meet the needs of the market because a lot of people do not want to use a chemical based cleaner in their home. Another solution attempts to use a sponge without the cleaner, but this solution is similarly unable to meet the needs of the market because of its construction and material properties a sponge alone is unable to remove all the dirt and stuck on filth. Still another solution seeks to use a sponge with abrasives such as steel wool or stiff fibers, but this solution also fails to meet market needs because these materials can be too abrasive and damage improved non-stick cooking surfaces and materials.

### SUMMARY OF THE INVENTION

An improved scrubbing device is disclosed. The scrubbing device is designed to deform and conform to multiple surface contours to provide an increased surface area for cleaning. Further, the device materials and properties allow for the cleaning of surfaces without the use of the potentially harsh chemicals.

The scrubbing device of the present invention is comprised of an exterior bag portion defining a generally spherical cavity for the receipt of a plurality of rigid beads, wherein the beads are retained within the cavity to provide a friction-generating surface. In the preferred embodiment of the present invention, the cavity is formed from a bag constructed out of a polyester material for flexibility and durability and filled to range of ninety percent (90%) to ninety-five percent (95%) of its capacity with small plastic beads. Preferably the diameter of the cavity portion is approximately two inches (2 in.) when partially filled with the beads of the present invention.

The materials and construction of the device provide for multiple uses for cleaning including use for vehicle washing and as a personal hygiene-cleaning device due to the presence of the beads contained within the bag portion. These material properties provide a scrubbing device and surface that resists mold, is reusable, machine washable, and provides an increased scrubbing surface area when compared to a traditional sponge.

The beads of the present invention and retained within the bag portion provide additional surface area to break down grime and grit while cleaning. Further, the air space between the beads further allows for improved drying properties resisting mold, mildew, and unwanted odors. The beads of the present invention are generally small and pellet sized, wherein multiple beads are necessary to fill the cavity space.

It is still further an advantage of the invention that it can be used with or without cleaning products to be natural and environmentally friendly.

Still further, the apparatus has a durable poly blend material cover for the bag portion.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows an isometric view of the device, according to the present invention;

FIG. 2 shows an isometric view of the device with the cover portion partially hidden to display the interior contents, according to the present invention;

FIG. 3 shows an isometric view a second embodiment of the device, according to the present invention; and

FIG. 4 shows an isometric view of a third embodiment of the device, according to the present invention.

### DETAILED DESCRIPTION OF THE INVENTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention is directed to be a cleaning device having an improved surface area for cleaning and scrubbing. The invention is in its most general sense a bag portion forming a sack and filled with beads to use for cleaning household surfaces, vehicles, or to be used as a body scrub in the shower or bathtub.

Preferably, the materials of the bag portion are constructed out of a polyester or polyester blend offering water permeability, flexibility, and durability. The bag portion is preferably filled with a plurality of small diameter plastic beads and fills cleaning needs from kitchen to bath to auto to outdoor. The device is cost effective due to its material properties allowing for it to be machine washable and environmentally friendly.

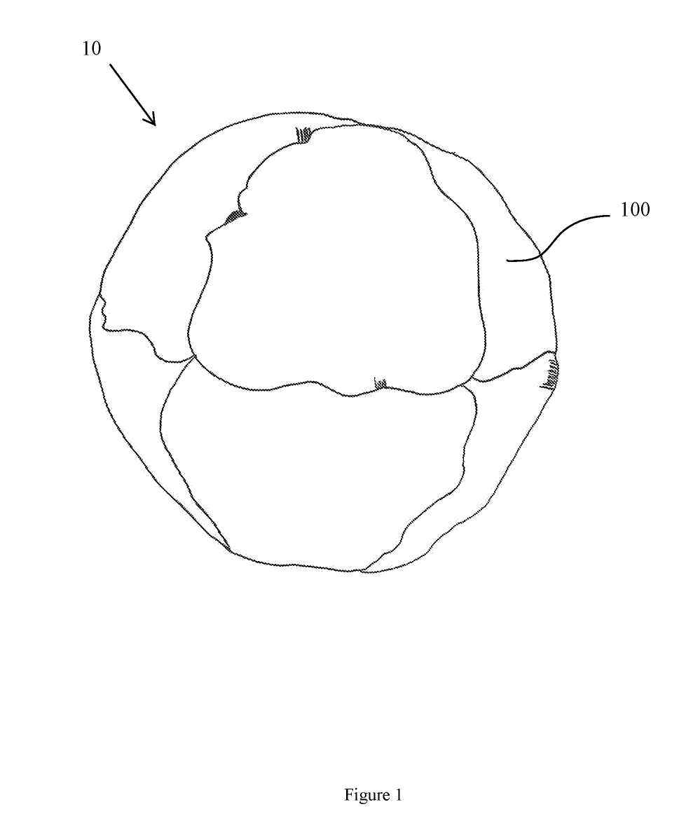

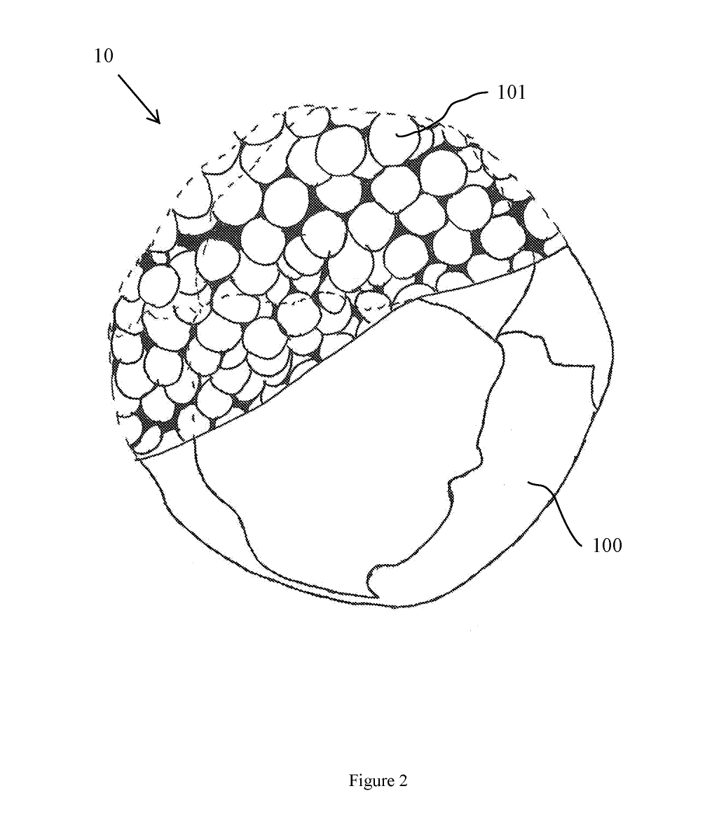

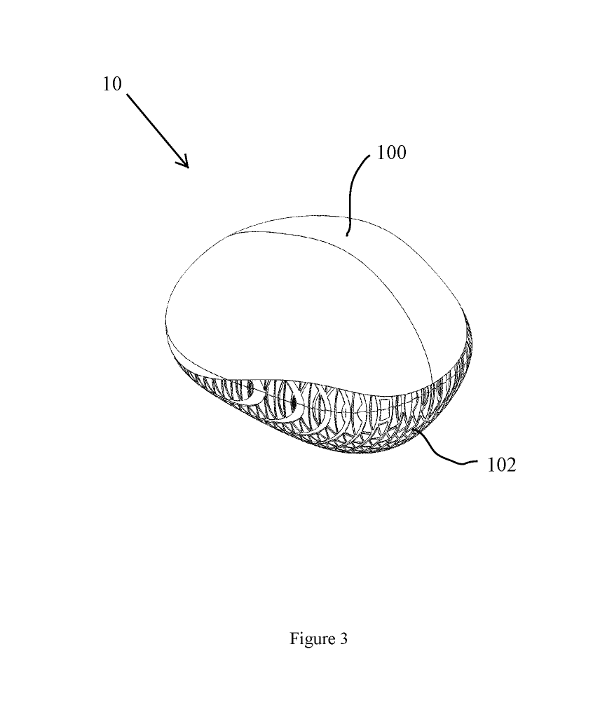

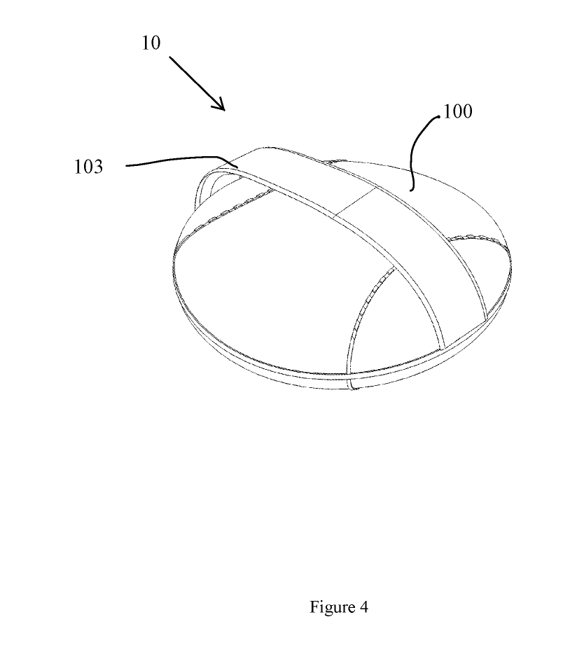

Referring to the figures, FIGS. 1-4 show first embodiment of the device (FIGS. 1-2), a second embodiment (FIG. 3), and third embodiment (FIG. 4) of the multi-surface scrubbing device of the present invention and generally referred to as device 10. The device 10 is generally spherical in shape and comprised of a bag portion 100 constructed out of a material having flexibility, water permeability, durability, and defining an interior cavity. Preferably this material is a polyester fiber or constructed out of polyester-like fibers and may include an elastic component, such as a spandex or elastane material. The interior cavity is sealed during construction and filled with a plurality of small pellet-like beads 101.

The beads 101 are rigid, spherical objects, resembling a BB and placed within the interior cavity to provide multiple distinct regions of pressure during scrubbing with the device. Preferably, the beads 100 are filled to between a range of ninety and ninety-five percent (90%-95%) of the capacity of the inner cavity of the bag portion 100, wherein multiple beads 100 are needed to fill the cavity space. In the preferred embodiment of the present invention, the beads 101 are constructed out of a rigid or hardened plastic material and spherical, although any similar material may be used. Preferably, the beads are spherical and sized with a diameter less than 9.4 mm (No. 000 buckshot). Preferably, the bag portion 100 is sized and shaped for easy receipt within the palm of a hand of the user and having a diameter of two inches (2 in.). Although a diameter of two inches is preferred, the device 10 could be provided in multiple sizes and shapes, wherein the device 10 may be provided in small, medium, and large sizes up to five inches (5 in.) in diameter.

The combination of the beads 101 secured within the bag portion 100 of the device 10 providing a flexible scrubbing surface that contours to the surface with the beads 101 providing friction to the object to be cleaned.

Referring now to FIG. 3, in a second embodiment of the device 10, according to the present invention, the bag portion 100 is provided in ovoid shape that is generally designed to conform a user's hand and including an additional scrubbing surface 102. The additional scrubbing surface 102 positioned on one side of the exterior of the bag portion 100 and generally providing raised nodes for additional friction.

Referring now to FIG. 4, in a third embodiment of the device 10, according to the present invention, the bag portion 100 is provided in a generally cylindrical shape and including a handle 103. The handle 103 positioned on a top side of the bag portion 100 opposite the scrubbing surface. The handle 103 extending a width of the bag portion 100 and allowing for grasping and securing, wherein the handle portion 103 is received along the back of a user's hand as the bag portion 100 is placed in the user's palm. The handle 103 may be removable for temporary use and may be configured in a shape wherein it is only affixed on one side of the bag portion 100.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A multi-surface scrubbing device, the device comprising:
a bag portion, the bag portion having a spherical shape and defining an interior cavity; and
a plurality of beads, the plurality of beads received within the interior cavity, wherein the beads are secured within the bag portion.

2. A device as in claim 1, wherein the plurality of beads fills between ninety percent and ninety-five percent of the interior cavity.

3. A device as in claim 2, wherein the device includes a handle.

4. A device as in claim 3, wherein the handle is removable.

5. A device as in claim 1, wherein the bag portion is comprised of a polyester material.

6. A device as in claim 1, wherein the plurality of beads is comprised of a rigid material.

7. A device as in clam 6, wherein the beads are comprised of a plastic material.

8. A device as in claim 1, wherein the diameter of the bag portion is two inches.

9. A scrubbing device, the scrubbing device designed for receipt within a palm of a hand of a user, the scrubbing device comprising:
a spherical bag portion, the bag portion defining an exterior scrubbing surface and an interior cavity, the interior cavity sealed from the exterior scrubbing surface after construction of the device; and
a plurality of beads, the beads being rigid and secured within the interior cavity of the spherical bag portion.

10. A scrubbing device, as in claim 9, wherein the in the scrubbing device interior cavity is filled to between ninety and ninety-five percent of its capacity with the plurality of beads.

11. A scrubbing device, as in claim 9, wherein the spherical bag portion is comprised of a water permeable polyester material.

12. A scrubbing device as in claim 11, wherein the plurality of beads is comprised of a plastic material.

13. A scrubbing device as is in claim 10, wherein the device includes a handle.

14. A scrubbing device as in claim 13, wherein the handle is removable.

15. A scrubbing device as in claim 10, wherein the exterior surface includes an additional scrubbing surface.

16. A scrubbing device as in claim 10, wherein the spherical bag portion is ovoid in shape.

17. A scrubbing device, the scrubbing device designed for receipt within a palm of a hand of a user, the scrubbing device comprising:
a bag portion, the bag portion defining an exterior scrubbing surface and an interior cavity, the interior cavity sealed from the exterior scrubbing surface and defining an interior space; and
a plurality of beads, the plurality of beads being rigid and secured within the interior cavity of the bag portion and occupying up to ninety-five percent of the interior space of the interior cavity.

18. A scrubbing device of claim 17, wherein the bag portion is spherical.

19. A scrubbing device as in claim 17, wherein the bag portion is comprised of a water permeable polyester material.

20. A scrubbing device as in claim 17, where the plurality of beads are comprised of a plastic material.
